(19) United States
(12) Patent Application Publication
(10) Pub. No.: US 2014/0059008 A1
(43) Pub. Date: Feb. 27, 2014

(54) RESOURCE ALLOCATION ANALYSES ON HYPOTHETICAL DISTRIBUTED COMPUTER SYSTEMS

(71) Applicant: Aashish Parikh, Santa Clara, CA (US)

(72) Inventor: Aashish Parikh, Santa Clara, CA (US)

(73) Assignee: VMWARE, INC., Palo Alto, CA (US)

(21) Appl. No.: 13/594,810

(22) Filed: Aug. 25, 2012

(51) Int. Cl. G06F 7/00; G06F 17/30

(52) U.S. Cl. 707/639; 707/E17.032; 707/E17.005

(57) ABSTRACT

A system and method for performing resource allocation analyses on hypothetical distributed computer systems uses a user-modified snapshot of a hypothetical distributed computer system to execute a resource allocation analysis. The user-modified snapshot includes configurations and resource usage information of at least some components of the hypothetical distributed computer system.

### BACKGROUND

Resource allocation techniques for distributed computer systems with resource-consuming clients, such as virtual machines (VMs), are important to ensure that the clients are operating at desired or target levels. For example, if a VM dedicated to sales is running on a host computer where CPU and memory are overextended to other VMs, that VM may not be able to process orders at an acceptable level. In such a situation, additional resources of the host computer should be allocated to the sales VM or the sales VM should be moved to another host computer that has sufficient resources so that the sales VM can run efficiently at or above the acceptable level.

Conventional resource allocation techniques make changes with respect to resource allocation in a distributed computer system by examining at least the current utilizations of various resources and the current requirements of the various components of the distributed computer system. The resource allocation techniques may involve load balancing and resource scheduling. These conventional resource allocation techniques work well to determine the best course of action for resource allocation for the current distributed computer system. However, if a user wants to see what effect a change in the current configuration of the distributed computer system or a change in the current requirements of one or more components of the distributed computer system would have on the resource allocation analysis, the user will have to actually make the configuration or requirement change and then see the results of a resource allocation algorithm. If the user wants to see what effect another change in the current configuration of the distributed computer system or another change in the requirements of one or more components of the distributed computer system would have on the resource allocation analysis, the user will have to make another configuration or requirement change in the distributed computer system and then see the results of the resource allocation algorithm.

### SUMMARY

A system and method for performing resource allocation analyses on hypothetical distributed computer systems uses a user-modified snapshot of a hypothetical distributed computer system to execute a resource allocation analysis. The user-modified snapshot includes configurations and resource usage information of at least some components of the hypothetical distributed computer system.

A method for performing resource allocation analyses on hypothetical distributed computer systems in accordance with an embodiment of the invention comprises providing a user interface to allow a user to create a user-modified snapshot of a hypothetical distributed computer system, the user-modified snapshot including configurations and resource usage information of at least some components of the hypothetical distributed computer system, and executing a resource allocation analysis using the user-modified snapshot of the hypothetical distributed computer system to produce resource allocation results for the hypothetical distributed computer system. In some embodiments, the steps of this method are performed when program instructions contained in a computer-readable storage medium is executed by one or more processors of a computer system.

A system in accordance with an embodiment of the invention comprises a processor and a resource allocation module operably connected to the processor. The resource allocation module comprises a snapshot editing unit configured to provide a user interface to allow a user to create a user-modified snapshot of a hypothetical distributed computer system, the snapshot including configurations of at least some components of the hypothetical distributed computer system, and a resource allocation analysis unit operably connected to the snapshot editing unit to receive the user-modified snapshot of the hypothetical distributed computer system. The resource allocation analysis unit is configured to execute a resource allocation process using the user-modified snapshot of the hypothetical distributed computer system to produce resource allocation results for the hypothetical distributed computer system.

Other aspects and advantages of embodiments of the present invention will become apparent from the following detailed description, taken in conjunction with the accompanying drawings, illustrated by way of example of the principles of the invention.

### BRIEF DESCRIPTION OF THE DRAWINGS

FIG. 1 is a block diagram of a distributed computer system in accordance with an embodiment of the invention.

FIG. 2 is a block diagram of a host computer in accordance with an embodiment of the invention.

FIG. 3 is a block diagram of a resource allocation module included in a management computer of the distributed computer system in accordance with an embodiment of the invention.

FIG. 4 is a block diagram of the management computer of the distributed computer system in accordance with another embodiment of the invention.

FIG. 5 is a flow diagram of a method for performing resource allocation analyses on hypothetical distributed computer systems in accordance with an embodiment of the invention.

Throughout the description, similar reference numbers may be used to identify similar elements.

### DETAILED DESCRIPTION

It will be readily understood that the components of the embodiments as generally described herein and illustrated in the appended figures could be arranged and designed in a wide variety of different configurations. Thus, the following more detailed description of various embodiments, as represented in the figures, is not intended to limit the scope of the present disclosure, but is merely representative of various embodiments. While the various aspects of the embodiments are presented in drawings, the drawings are not necessarily drawn to scale unless specifically indicated.

The present invention may be embodied in other specific forms without departing from its spirit or essential characteristics. The described embodiments are to be considered in all respects only as illustrative and not restrictive. The scope of the invention is, therefore, indicated by the appended claims rather than by this detailed description. All changes which come within the meaning and range of equivalency of the claims are to be embraced within their scope.

Reference throughout this specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussions of the features and advantages, and similar language, throughout this specification may, but do not necessarily, refer to the same embodiment.

Furthermore, the described features, advantages, and characteristics of the invention may be combined in any suitable manner in one or more embodiments. One skilled in the relevant art will recognize, in light of the description herein, that the invention can be practiced without one or more of the specific features or advantages of a particular embodiment. In other instances, additional features and advantages may be recognized in certain embodiments that may not be present in all embodiments of the invention.

Reference throughout this specification to “one embodiment,” “an embodiment,” or similar language means that a particular feature, structure, or characteristic described in connection with the indicated embodiment is included in at least one embodiment of the present invention. Thus, the phrases “in one embodiment,” “in an embodiment,” and similar language throughout this specification may, but do not necessarily, all refer to the same embodiment.

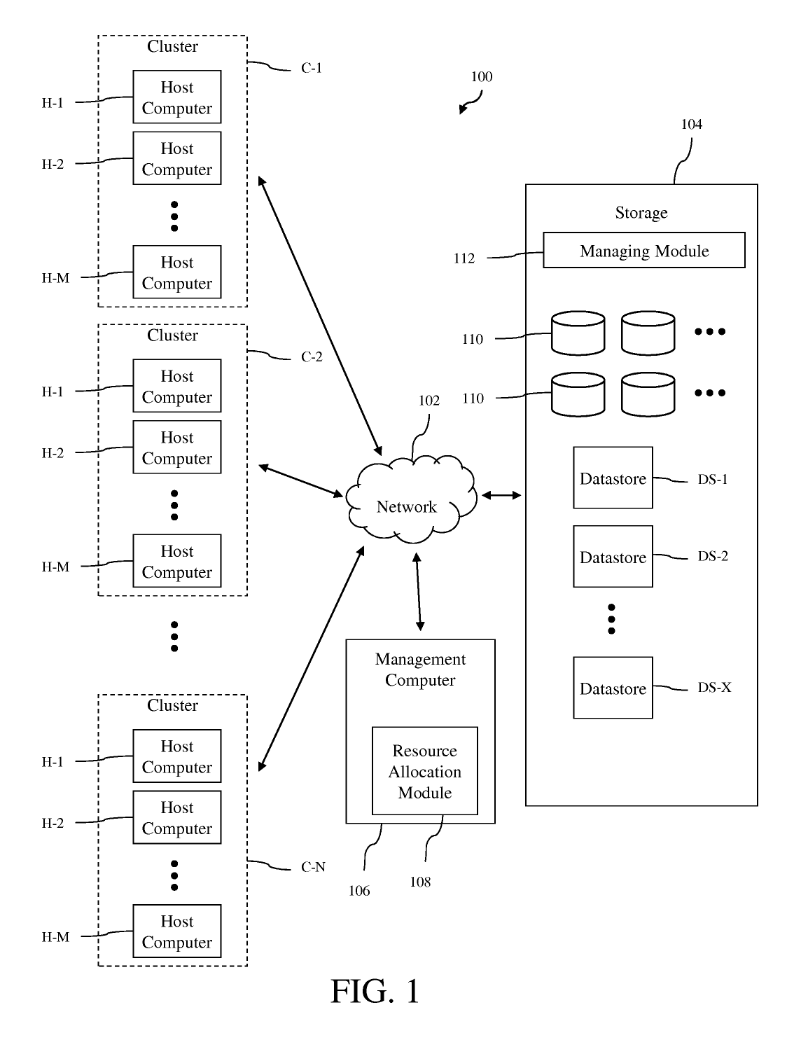

Turning now to FIG. 1, a distributed computer system 100 in accordance with an embodiment of the invention is shown. As shown in FIG. 1, the distributed computer system includes a network 102, clusters C-1, C-2 . . . C-N (where N is a positive integer) of host computers, storage 104 and a management computer 106 with a resource allocation module 108. The exact number of host computer clusters included in the distributed computer system can be any number of clusters from few clusters to tens of clusters or more. The host computers of the different clusters, the storage and the management computer are connected to the network. Thus, each of the host computers in the clusters and the management computer are able to access the storage via the network and may share the resources provided by the storage. Consequently, any process running on any of the host computers and the management computer may also access the storage via the network.

In the illustrated embodiment, each of the clusters C-1, C-2 . . . C-N includes a number of host computers H-1, H-2 . . . H-M (where M is a positive integer). The number of host computers included in each of the clusters can be any number from one to several hundred or more. In addition, the number of host computers included in each of the clusters can vary so that different clusters can have different number of host computers. The host computers are physical computer systems that host or support one or more clients so that the clients are executing on the physical computer systems. As used herein, the term “client” is any software entity that can run on a computer system, such as a software application, a software process or a virtual machine (VM). The host computers may be servers that are commonly found in data centers. As an example, the host computers may be servers installed in one or more server racks. Typically, the host computers of a cluster are located within the same server rack.

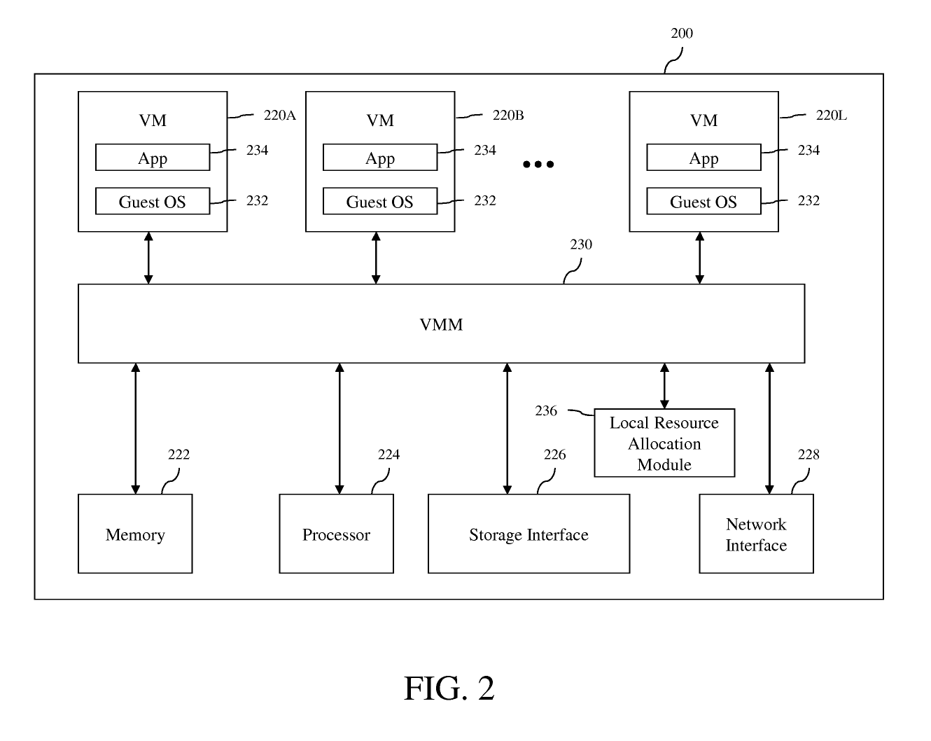

Turning now to FIG. 2, components of a host computer 200 that is representative of the host computers H-1, H-2 . . . H-M in the clusters C-1, C-2 . . . C-N in accordance with an embodiment of the invention are shown. In FIG. 2, the physical connections between the various components of the host computer are not illustrated. In the illustrated embodiment, the host computer is configured to support a number of clients 220A, 220B . . . 220L (where L is a positive integer), which are VMs. The number of VMs supported by the host computer can be anywhere from one to more than one hundred. The exact number of VMs supported by the host computer is only limited by the physical resources of the host computer. The VMs share at least some of the hardware resources of the host computer, which include system memory 222, one or more processors 224, a storage interface 226, and a network interface 228. The system memory 222, which may be random access memory (RAM), is the primary memory of the host computer. The processor 224 can be any type of a processor, such as a central processing unit (CPU) commonly found in a server. The storage interface 226 is an interface that allows that host computer to communicate with the storage 104. As an example, the storage interface may be a host bus adapter or a network file system interface. The network interface 228 is an interface that allows the host computer to communicate with other devices connected to the network 102. As an example, the network interface may be a network adapter.

In the illustrated embodiment, the VMs 220A, 220B . . . 220L run on top of a virtual machine monitor (VMM) 230, which is a software interface layer that enables sharing of the hardware resources of the host computer 200 by the VMs. However, in other embodiments, one or more of the VMs can be nested, i.e., a VM running in another VM. For example, one of the VMs may be running in a VM, which is also running in another VM. The virtual machine monitor may run on top of the host computer's operating system or directly on hardware of the host computer. In some embodiments, the virtual machine monitor runs on top of a hypervisor that is installed on top of the hardware components of the host computer. With the support of the virtual machine monitor, the VMs provide virtualized computer systems that give the appearance of being distinct from the host computer and from each other. Each VM includes a guest operating system 232 and one or more guest applications 234. The guest operating system is a master control program of the respective VM and, among other things, the guest operating system forms a software platform on top of which the guest applications run.

Similar to any other computer system connected to the network 102, the VMs 220A, 220B . . . 220L are able to communicate with other computer systems connected to the network using the network interface 228 of the host computer 200. In addition, the VMs are able to access the storage 104 using the storage interface 226 of the host computer.

The host computer 200 also includes a local resource allocation module 236 that operates as part of a resource management system, such as a distributed resource scheduler system, to manage resources consumed by the VMs 220A, 220B . . . 220L. Although the local resource allocation module is illustrated in FIG. 2 as being separate from the virtual machine monitor 230, the local resource allocation module may be implemented as part of the virtual machine monitor. In some embodiments, the local resource allocation module is implemented as software program running on the host computer. However, in other embodiments, the local resource allocation module may be implemented using any combination of software and hardware.

Turning back to FIG. 1, the network 102 can be any type of computer network or a combination of networks that allows communications between devices connected to the network. The network 102 may include the Internet, a wide area network (WAN), a local area network (LAN), a storage area network (SAN), a fibre channel network and/or other networks. The network 102 may be configured to support protocols suited for communications with storage arrays, such as Fibre Channel, Internet Small Computer System Interface (iSCSI), Fibre Channel over Ethernet (FCoE) and HyperSCSI.

The storage 104 is used to store data for the host computers H-1, H-2 . . . H-M of the clusters C-1, C-2 . . . C-N, which can be accessed like any other storage device connected to computer systems. In an embodiment, the storage can be accessed by entities, such as clients running on the host computers, using any file system, e.g., virtual machine file system (VMFS) or network file system (NFS). The storage includes one or more computer data storage devices 110, which can be any type of storage devices, such as solid-state devices (SSDs), hard disks or a combination of the two. The storage devices may operate as components of a network-attached storage (NAS) and/or a storage area network (SAN). The storage includes a storage managing module 112, which manages the operation of the storage. In an embodiment, the storage managing module is a computer program executing on one or more computer systems (not shown) of the storage. The storage supports multiple datastores DS-1, DS-2 . . . DS-X (where X is a positive integer), which may be identified using logical unit numbers (LUNs). In an embodiment, the datastores are virtualized representations of storage facilities. Thus, each datastore may use the storage resource from more than one storage device included in the storage. The datastores are used to store data associated with the clients supported by the host computers of the clusters. For virtual machines, the datastores may be used to store virtual storage, e.g., virtual disks, used by each of the virtual machines, as well as other files needed to support the virtual machines. One or more datastores may be associated with one or more host computers. Thus, each host computer is associated with at least one datastore. Some of the datastores may be grouped into one or more clusters of datastores, which are commonly referred to as storage pods.

The management computer 106 operates to monitor and manage the host computers H-1, H-2 . . . H-M of the clusters C-1, C-2 . . . C-N and/or the storage 104 of the distributed computer system 100. The management computer may be configured to monitor the current configurations of the host computers and the clients running on the host computers, for example, virtual machines (VMs). The monitored configurations may include hardware configuration of each of the host computers, such as CPU type and memory size, and/or software configurations of each of the host computers, such as operating system (OS) type and installed applications or software programs. The monitored configurations may also include clustering information, i.e., which host computers are included in which clusters. The monitored configurations may also include client hosting information, i.e., which clients, e.g., VMs, are hosted or running on which host computers. The monitored configurations may also include client information. The client information may include size of each of the clients, virtualized hardware configuration of each of the clients, such as virtual CPU type and virtual memory size, software configuration of each of the clients, such as OS type and installed applications or software programs running on each of the clients, and virtual storage size for each of the clients. The client information may also include resource settings, such as limit, reservation, entitlement and share values for various resources, e.g., CPU, memory, network bandwidth and storage, which are consumed by the clients.

The management computer 106 may also be configured to monitor the current configuration of the storage 104, including the physical storage devices 110 and the datastores DS-1, DS-2 . . . DS-X of the storage. The monitored storage configuration may include storage device configuration, which may include the number of storage devices in the storage, the device type of the storage devices, such as solid-state devices (SSDs) and hard disks, and storage capacity of each of the storage devices. The monitored storage configuration may also include datastore configuration, such as storage capacity of each of the datastores and connections and associations between the datastores and the host computers H-1, H-2 . . . H-M and/or the clients running on the host computers.

The management computer 106 may also be configured to monitor the current usage of resources by the clients, the host computers H-1, H-2 . . . H-M and the clusters C-1, C-2 . . . C-N of host computers. Thus, the management computer may monitor CPU processing usage, memory usage, network usage and storage usage of the clients. The management computer may also be configured to store the usage of resources by the clients, the host computers and the clusters of host computers to maintain historical resource usage information. The historical resource usage information can then be used to develop various resource usage statistics for the individual clients, the individual host computers and the individual clusters of host computers.

The management computer 106 may also be configured to perform various operations to manage the clients, the host computers H-1, H-2 . . . H-M, the clusters C-1, C-2 . . . C-N of host computers and the storage 104. As an example, the management computer may be configured to initially place new clients onto one or more of the host computers in particular clusters and move existing clients to different host computers and/or different clusters. As another example, the management computer may be configured to power down particular clients and/or host computers to conserve power. The management computer may also be configured to implement resource allocation recommendations made by the resource allocation module 108, as explained below. In order to perform these various operations, the management computer may maintain requirements and preferences for the clients with respect to the host computers and the datastores. These requirements and preferences may include affinity or anti-affinity rules for some of the clients, which may be mandatory or preferential. For example, these affinity or anti-affinity rules may include rules that specify which clients should run on the same host computer or be kept on separate host computers. As another example, these affinity or anti-affinity rules may include rules that specify which host computers are acceptable to clients and which host computers are not. The management computer may be configured or programmed to perform other operations to manage the distributed computer system 100. In an implementation, the management computer is a VMware vCenter™ server with at least some of the features available for such server.

The resource allocation module 108 operates in at least one of two operating modes, a normal operating mode and a hypothetical operating mode. The resource allocation module may be periodically activated, i.e., called to run, at predefined intervals, for example, every five minutes. In addition, the resource allocation module may be activated at will when certain events or conditions occur. For example, the resource allocation module may be activated when one of the host computers is shut down for maintenance or a new VM needs to be placed in the distributed computer system 100. Alternatively, the resource allocation module may be activated manually by a user of the management computer 106.

In a normal operating mode, the resource allocation module 108 performs a resource allocation analysis to make resource allocation recommendations on the distributed computer system 100, including any initial client placement and client relocation recommendations, using a current snapshot of the distributed computer system. However, in a hypothetical operating mode, the resource allocation module allows a user, such as a system administrator, to create a user-modified snapshot of a hypothetical distributed computer system so that a resource allocation analysis can be made on the user-modified snapshot, as described in more detail below. This allows the user to make up different “what if” scenarios for the distributed computer system to see what effect the different scenarios would have on the resource allocation analysis results. Thus, the hypothetical operating mode of the resource allocation module allows the user to essentially run resource allocation analyses on different distributed computer systems without having to actually configure the distributed computer system into such different distributed computer systems. In other words, the hypothetical operating mode of the resource allocation module allows the user to run resource allocation analyses on imaginary distributed computer systems to get results without having to create or configure such distributed computer systems in the real world and run the resource allocation analyses on the real distributed computer systems.

As used herein a snapshot of an actual distributed computer system contains at least configuration and resource usage information of the distributed computer system at a particular moment in time. The snapshot may include the current configurations of host computers and clients running on the host computers in the distributed computer system. These configurations of the host computer and the clients may include hardware and software configurations of each host computer, clustering information, client hosting information and client information, which were described above with respect to the management computer 106. The snapshot may also include the current configuration of storage in the distributed computer system, including the configurations of storage devices and datastores of the storage. In addition, the snapshot may also include requirements and preferences of components in the distributed computer system. The snapshot may also include resource usage information for various components of the distributed computer system, including historical resource usage information regarding the distributed computer system. Lastly, the snapshot may also include resource allocation statistics, such as how often a client has been moved to different host computers or how often a client has consumed the entire resource allotted to that client.

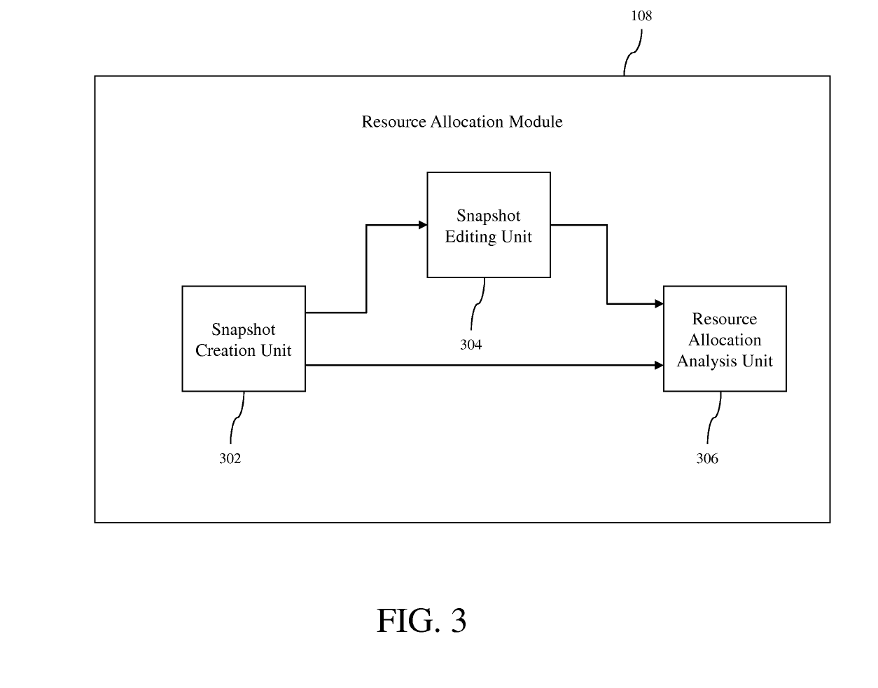

Turning now to FIG. 3, a block diagram of components of the resource allocation module 108 in the management computer 106 in accordance with an embodiment of the invention is shown. As illustrated in FIG. 3, the resource allocation module 108 includes a snapshot creation unit 302, a snapshot editing unit 304 and a resource allocation analysis unit 306. These components of the resource allocation module can be implemented as software, hardware or a combination of software and hardware. In other embodiments, the resource allocation module may include other components found in conventional resource allocation modules. In a particular implementation, the resource allocation module is a distributed resource scheduler (DRS) installed in a VMware vCenter™ server that is executed by one or more processor of a computer system. However, in other embodiments, the resource allocation module may be installed in any other computer system.

The snapshot creation unit 302 operates to create a snapshot of the distributed computer system 100 using the information obtained by the resource allocation module 108. The snapshot creation unit interfaces with other components of the management computer 106 to obtain the information needed to generate the snapshot. In an embodiment, the snapshot is a memory object, which is produced by dumping one or more memories of the management computer. The size of the snapshot can vary, but in a particular implementation, the size of the snapshot is not larger than twenty (20) megabytes. If the resource allocation module is operating in a normal operating mode, the generated snapshot is directly transmitted to the resource allocation analysis unit 306 for processing. If the resource allocation module is operating in a hypothetical operating mode, the generated snapshot is transmitted to the snapshot editing unit 304 so that the snapshot can be edited by a user of the management computer, e.g., a system administrator. Alternatively, a clone of the generated snapshot is made and the snapshot clone is transmitted to the snapshot editing unit. As used herein, a clone of a snapshot is a copy of the snapshot. If a snapshot clone is generated, the original snapshot can be transmitted to the resource allocation analysis unit for processing.

The snapshot editing unit 304 operates to allow the user to edit the original snapshot or the snapshot clone so that a resource allocation analysis algorithm can be performed by the resource allocation analysis unit 306 using the user-modified snapshot rather than the original snapshot. The user-modified snapshot can be viewed as a snapshot of an imaginary or hypothetical distributed computer system, which is similar to the distributed computer system 100 but has been virtually changed with respect to some aspect of the distributed computer system by the user. The snapshot can be edited with respect to the configuration of the clients, the host computers and/or the storage. For example, the snapshot can be edited so that a particular host computer has fewer or additional clients, e.g., VMs. As another example, the snapshot can be edited so that additional host computers are added to the distributed computer system or one or more host computers are removed from the distributed computer system. As another example, the snapshot can be edited so that additional storage devices are available in the storage 104 or fewer storage devices are available in the storage. The snapshot can be edited with respect to resource allocation requirements of the clients. For example, the snapshot can be edited so that resource limit, reservation and/or share values for one or more clients are changed. The snapshot can be edited with respect to requirements and preferences, e.g., affinity rules, for the clients. For example, the snapshot can be edited so that all the affinity rules for the clients are removed.

In an embodiment, the snapshot editing unit 304 provides a user interface, which allows the user to edit, e.g., add, delete and/or change, any aspect of a snapshot or a snapshot clone. The user interface may be a graphical user interface or any user interface that allows a user to edit or modify any content of the snapshot. In an embodiment, the snapshot editing unit may allow a user to create a user-modified snapshot from scratch rather than modifying an existing snapshot.

The resource allocation analysis unit 306 operates to process the received snapshot using at least one of conventional resource allocation analysis algorithms to generate one or more recommendations regarding resource allocations for the distributed computer system represented in the received snapshot. In addition to the recommendations, the resource allocation analysis unit may also present various metrics related to resource allocation. The received snapshot may be an actual snapshot of the distributed computer system 100, which is processed during a normal operating mode. Alternatively, the received snapshot may be a user-modified snapshot, including a user created snapshot, which is processed during a hypothetical operating mode. The resource allocation analysis unit will process the received snapshot in the same manner regardless of whether the received snapshot is an actual snapshot or a user-modified snapshot. This is because the resource allocation analysis unit cannot distinguish between an actual snapshot and a user-modified snapshot. Thus, the resource allocation analysis unit will process a received snapshot of a distributed computer system regardless of whether the distributed computer system represented by the received snapshot is real or imaginary.

The results of the resource allocation analysis executed by the resource allocation analysis unit 306 may include a recommendation to maintain the current configurations and resource allocations, as defined in the received snapshot, i.e., a recommendation to make no changes to the current configurations and resource allocations. Alternatively, the results of the resource allocation analysis may include a recommendation to move one or more clients from their current host computers, as defined in the received snapshot, to other host computers and/or a recommendation to power down one or more clients or host computers, as defined in the received snapshot, to conserve power. The results of the resource allocation analysis may also include a recommendation to change the resource entitlement for one or more clients or host computers based at least on the current usage of a particular resource, as defined in the received snapshot. In an embodiment, for a normal operating mode, at least one of the recommendations made by the resource allocation analysis unit is used by the management computer 106 to automatically execute that recommendation. Alternatively, for a normal operating mode, at least one of the recommendations may be presented to a user in any format, for example, on a computer monitor, so that the user can decide to follow the recommendation, ignore the recommendation or take some other action in response to the recommendation. For a hypothetical operating mode, the recommendations are only presented to the user in any format, for example, on a computer monitor, so that the user can examine the recommendations.

The results of the resource allocation analysis executed by the resource allocation analysis unit 306 may further include metrics related to resource allocation. For example, these metrics may include, but not limited to, (a) CPU utilization with respect to percentage overcommitted per host computer or per cluster, (b) CPU ready time per client or per host computer (aggregate), (c) memory utilization with respect to percentage overcommitted per host computer or per cluster, (d) memory access latency per client or per host computer, (e) balance metric per cluster, (f) average and peak numbers of clients per host computer, (g) power consumed per host computer or per cluster (aggregate or average), (h) storage latency per host computer or per datastore, (i) storage queue depth per host computer, (j) percentage of time storage is enabled, (k) space usage per virtual disk, per datastore or per storage pod, (l) space usage with respect to percentage thin provisioned, (m) latency per datastore or per storage pod, (n) throughput per datastore or per storage pod, (o) host-datastore connectivity percentage, (p) input/output load balancing (enabled or not), (q) average and peak numbers of virtual disks per datastore, (r) number of network ports used or free per client or per host computer, and (s) chargeback with respect to current charges. For a hypothetical operating mode, these metrics can be used by the user to see how the hypothetical distributed computer system, which was virtually created using the user-modified snapshot, would fare with respect to resource allocation.

In an embodiment, the snapshot editing unit 304 may operate using queries to produce user-modified snapshots. In this embodiment, a user would enter a query about a specific modification to the current distributed computer system 100 using a user interface provided by the snapshot editing unit. In response to the query, the snapshot editing unit would modify the snapshot of the distributed computer system accordingly, and then transmit the user-modified snapshot to the resource allocation analysis unit 306 for processing. As an example, the query entered by the user may be “If I upgrade the inventory to add two hosts of type 1, remove one host of type 2 and add 10 new VMs, what will the new cost be?” For this query, the snapshot editing unit would modify the snapshot of the current distributed computer system to reflect these changes, and then transmit the user-modified snapshot to the resource allocation analysis unit 306, which would process the user-modified snapshot and produce the answer in terms of one or more relevant metrics, e.g., metric for current charges. The following is a list of additional query examples. This is not an exhaustive list.
(1) “If I upgrade these hosts in my clusters, what will my new inventory look like? What will the new balance number be? What will my new IOPS be with respect to storage?”
(2) “If I remove this affinity rule, what will be the new health of my clients/hosts/cluster?”
(3) Which are the 4 least loaded hosts that I can put into maintenance mode to upgrade them to the new build?”
(4) “Why can you not reach my target balance?”
(5) “If I make these changes to my inventory, what will the new ready time numbers look like? What will balance number look like?”
(6) “If I added a clone of host4 to, remove host3 from and added 10 clones on vm24 to my cluster, what will the new inventory look like? How many migrations will be scheduled?”
(7) “If I break this VM-VM affinity rule, what will my new average VMs-per-host number be?”
(8) “If I enable power management mode on this host, these hosts or on all hosts in the cluster, what will my new power consumption numbers be?”
(9) “If I enable power management mode in the cluster and provide a cost/watt number, what will my electricity bill be reduced by?”
(10) “If I connect these hosts to this datastore, what will my new connectivity percentage be? Will input/output load balancing become enable in my storage pod?”
(11) “If I had two clones of datastore1 in my storage pod, what will the new inventory look like? How many migrations will be scheduled?”
(12) “If I enable Host Based Replication (HBR) on these hosts in my cluster, what will be the result of the resource allocation analysis?”
(13) “If I enabled (or disabled) Site Recovery Manager (SRM) on these datastores in my storage pod, what will be the result of the resource allocation analysis?”
(14) “If I enable Enhanced VMotion Compatibility (EVC), what will be the result of the resource allocation analysis with respect to load balancing?”

In the embodiment illustrated in FIG. 3, the resource allocation module 108 includes only one resource allocation analysis unit that can process either an actual snapshot or a user-modified snapshot. However, in other embodiments, the resource allocation module may include multiple resource allocation analysis units to process multiple snapshots. For example, the resource allocation module may include two resource allocation processing units, one unit dedicated to processing actual snapshots and another unit dedicated to processing user-modified snapshots.

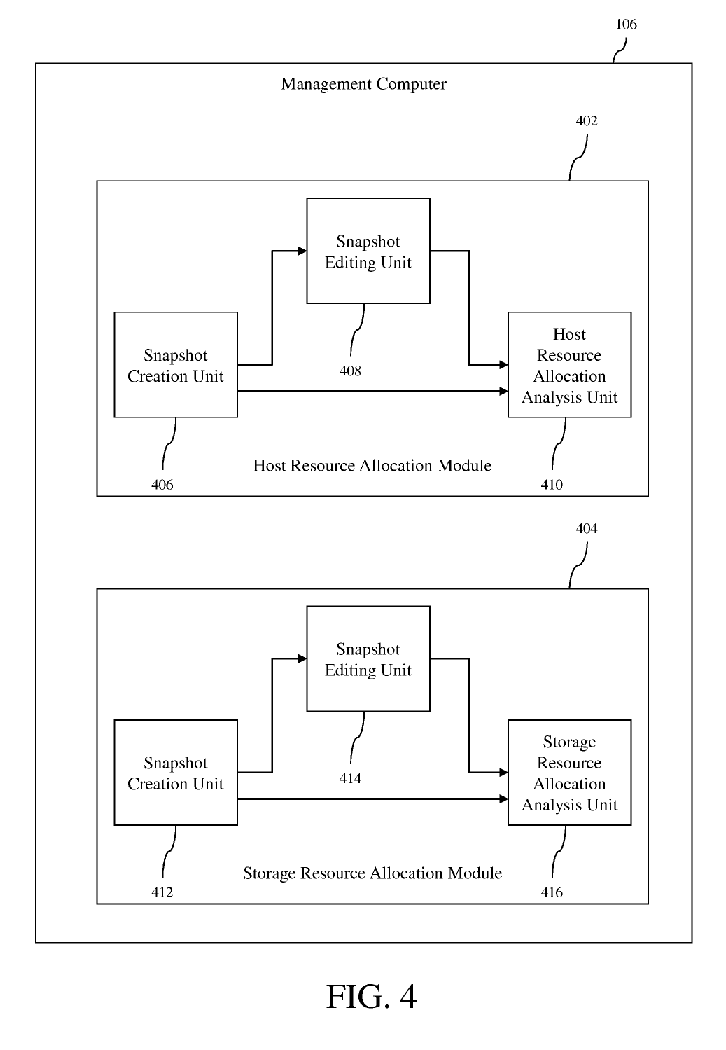

Turning now to FIG. 4, the management computer 106 in accordance with another embodiment of the invention is shown. In this embodiment the management computer includes a host resource allocation module 402 and a storage resource allocation module 404. The host resource allocation module handles allocation of resources provided by the host computers H-1, H-2 . . . H-M in the clusters C-1, C-2 . . . C-N. In an implementation, the host resource allocation module is part of a distributed resource scheduler (DRS) provided by VMware, Inc., and thus, may include some of the features and functionalities of such DRS. The storage resource allocation module handles allocation of storage resources provided by the storage 104. In an implementation, the storage resource allocation module is part of a storage distributed resource scheduler (SDRS) provided by VMware, Inc., and thus, may include some of the features and functionalities of such SDRS.

The host resource allocation module 402 is similar to the resource allocation module 108 shown in FIG. 3. However, the host resource allocation module performs allocation analysis with respect to resources only provided by the host computers H-1, H-2 . . . H-M. Thus, the host resource allocation module does not handle allocation of storage resources provided by the storage 104. Similar to the resource allocation module 108, the host resource allocation module includes a snapshot creation unit 406, a snapshot editing unit 408, and a host resource allocation analysis unit 410. These units of the host resource allocation module operate in a similar manner as the units of the resource allocation module. The snapshot creating unit 406 is configured to create a snapshot of the distributed computer system 100. In particular, the snapshot created by the snapshot creating unit includes information regarding the host computers in the distributed computer system and the clients running on the host computers. However, the snapshot created by the snapshot creating unit may not include information regarding the storage. The snapshot editing unit 408 is configured to provide a user interface for a user to generate a user-modified snapshot of a hypothetical distributed computer system. The user-modified snapshot can be generated from the original snapshot created by the snapshot creating unit 406 or a snapshot clone of the original snapshot, or can be created from scratch by the user. The host resource allocation analysis unit 410 is configured to perform a resource allocation analysis on the original snapshot during a normal operating mode or on the user-modified snapshot during a hypothetical operating mode. The results of the resource allocation analysis, which can include one or more recommendations and various metrics of the distributed computer system represented by the processed snapshot, can then be presented to the user. During the normal operating mode, one or more of the recommendations can be executed automatically, if such feature has been activated.

The storage resource allocation module 404 is also similar to the resource allocation module 108 shown in FIG. 3. However, the storage resource allocation module performs allocation analysis with respect to resources only provided by the storage 104. Thus, the storage resource allocation module does not handle allocation of resources provided by the host computers H-1, H-2 . . . H-M, such as CPU and memory resources. Similar to the resource allocation module 108, the storage resource allocation module includes a snapshot creation unit 412, a snapshot editing unit 414 and a storage resource allocation analysis unit 416. These units of the storage resource allocation module operate in a similar manner as the units of the resource allocation module. The snapshot creating unit 412 is configured to create a snapshot of the distributed computer system 100. In particular, the snapshot created by the snapshot creating unit includes information regarding the storage devices 110 and/or datastores DS-1, DS-2 . . . DS-X of the storage. However, the snapshot created by the snapshot creating unit may not include information regarding the resources provided by the host computers. The snapshot editing unit 414 is configured to provide a user interface for a user to generate a user-modified snapshot of a hypothetical distributed computer system. The user-modified snapshot can be generated from the original snapshot created by the snapshot creating unit or a snapshot clone of the original snapshot, or can be created from scratch by the user. The storage resource allocation analysis unit 416 is configured to perform a resource allocation analysis on the original snapshot during a normal operating mode or on the user-modified snapshot during a hypothetical operating mode. The results of the resource allocation analysis, which can include one or more recommendations and various metrics of the distributed computer system represented by the processed snapshot, can then be presented to the user. During the normal operating mode, one or more of the recommendations can be executed automatically, if such feature has been activated.

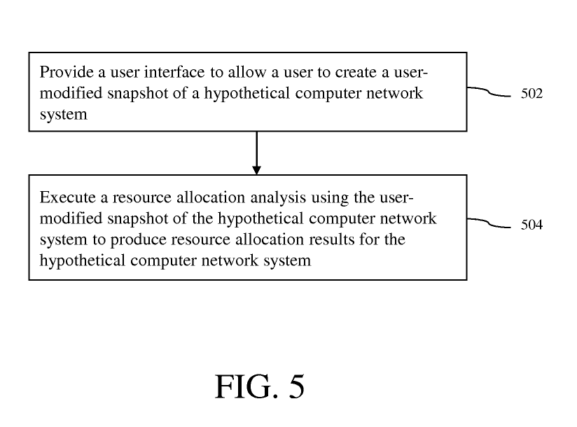

A method for performing resource allocation analyses on hypothetical distributed computer systems in accordance with an embodiment of the invention is described with reference to a flow diagram of FIG. 5. At block 502, a user interface to allow a user to create a user-modified snapshot of a hypothetical distributed computer system is provided. The user-modified snapshot includes configurations and resource usage information of at least some components of the hypothetical distributed computer system. At block 504, a resource allocation analysis using the user-modified snapshot of the hypothetical distributed computer system is executed to produce resource allocation results for the hypothetical distributed computer system.

Although the operations of the method(s) herein are shown and described in a particular order, the order of the operations of each method may be altered so that certain operations may be performed in an inverse order or so that certain operations may be performed, at least in part, concurrently with other operations. In another embodiment, instructions or sub-operations of distinct operations may be implemented in an intermittent and/or alternating manner.

It should also be noted that at least some of the operations for the methods may be implemented using software instructions stored on a computer useable storage medium for execution by a computer. As an example, an embodiment of a computer program product includes a computer useable storage medium to store a computer readable program that, when executed on a computer, causes the computer to perform operations, as described herein.

Furthermore, embodiments of at least portions of the invention can take the form of a computer program product accessible from a computer-usable or computer-readable medium providing program code for use by or in connection with a computer or any instruction execution system. For the purposes of this description, a computer-usable or computer readable medium can be any apparatus that can contain, store, communicate, propagate, or transport the program for use by or in connection with the instruction execution system, apparatus, or device.

The computer-useable or computer-readable medium can be an electronic, magnetic, optical, electromagnetic, infrared, or semiconductor system (or apparatus or device), or a propagation medium. Examples of a computer-readable medium include a semiconductor or solid state memory, magnetic tape, a removable computer diskette, a random access memory (RAM), a read-only memory (ROM), a rigid magnetic disc, and an optical disc. Current examples of optical discs include a compact disc with read only memory (CD-ROM), a compact disc with read/write (CD-R/W), a digital video disc (DVD), and a Blu-ray disc.

In the above description, specific details of various embodiments are provided. However, some embodiments may be practiced with less than all of these specific details. In other instances, certain methods, procedures, components, structures, and/or functions are described in no more detail than to enable the various embodiments of the invention, for the sake of brevity and clarity.

Although specific embodiments of the invention have been described and illustrated, the invention is not to be limited to the specific forms or arrangements of parts so described and illustrated. The scope of the invention is to be defined by the claims appended hereto and their equivalents.

What is claimed is:

1. A method for performing resource allocation analyses on hypothetical distributed computer systems, the method comprising:
providing a user interface to allow a user to create a user-modified snapshot of a hypothetical distributed computer system, the user-modified snapshot including configurations and resource usage information of at least some components of the hypothetical distributed computer system; and
executing a resource allocation analysis using the user-modified snapshot of the hypothetical distributed computer system to produce resource allocation results for the hypothetical distributed computer system.

2. The method of claim 1, further comprising creating an original snapshot of an actual distributed computer system, wherein the user-modified snapshot is derived from the original snapshot.

3. The method of claim 2, further comprising obtaining a snapshot clone of the original snapshot of the actual distributed computer system, wherein the user-modified snapshot is a modified version of the snapshot clone.

4. The method of claim 2, wherein the user-modified snapshot is a modified version of the original snapshot of the actual distributed computer system.

5. The method of claim 2, wherein the original snapshot of the actual distributed computer system includes configurations and resource usage information of at least some components of the actual distributed computer system.

6. The method of claim 5, wherein the original snapshot of the actual distributed computer system includes configurations of host computers in the actual distributed computer system and clients running on at least some of the host computers.

7. The method of claim 5, wherein the original snapshot of the actual distributed computer system includes configurations of storage devices in the actual distributed computer system.

8. The method of claim 2, wherein the original snapshot of the actual distributed computer system includes requirements of at least some components of the actual distributed computer system.

9. The method of claim 8, wherein the original snapshot of the actual distributed computer system includes requirements of clients running on host computers in the actual distributed computer system.

10. The method of claim 9, wherein the clients running on the host computers in the actual distributed computer system include virtual machines.

11. A computer system comprising:
a processor; and
a resource allocation module operably connected to the processor, the resource allocation module comprising:
a snapshot editing unit configured to provide a user interface to allow a user to create a user-modified snapshot of a hypothetical distributed computer system, the snapshot including configurations of at least some components of the hypothetical distributed computer system; and
a resource allocation analysis unit operably connected to the snapshot editing unit to receive the user-modified snapshot of the hypothetical distributed computer system, the resource allocation processing unit being configured to execute a resource allocation process using the user-modified snapshot of the hypothetical distributed computer system to produce resource allocation results for the hypothetical distributed computer system.

12. The system of claim 11, wherein the resource allocation module further comprises a snapshot creation unit configured to create an original snapshot of an actual distributed computer system, wherein the user-modified snapshot is derived from the original snapshot.

13. The system of claim 12, wherein the snapshot editing unit is configured to obtain a snapshot clone of the original snapshot of the actual distributed computer system, wherein the user-modified snapshot is a modified version of the snapshot clone.

14. The system of claim 12, wherein the user-modified snapshot is a modified version of the original snapshot of the actual distributed computer system.

15. The system of claim 12, wherein the original snapshot of the actual distributed computer system includes configurations and resource usage information of at least some components of the actual distributed computer system.

16. The system of claim 15, wherein the original snapshot of the actual distributed computer system includes configurations of host computers in the actual distributed computer system and clients running on at least some of the host computers.

17. The system of claim 15, wherein the original snapshot of the actual distributed computer system includes configurations of storage devices in the actual distributed computer system.

18. The system of claim 12, wherein the original snapshot of the actual distributed computer system includes requirements of at least some components of the actual distributed computer system.

19. The system of claim 18, wherein the original snapshot of the actual distributed computer system includes requirements of clients running on host computers in the actual distributed computer system.

20. The system of claim 19, wherein the clients running on the host computers in the actual distributed computer system include virtual machines.

21. A computer-readable storage medium containing program instructions for allocating resources using hypothetical scenarios of distributed computer systems, wherein execution of the program instructions by one or more processors of a computer system causes the one or more processors to perform steps comprising:
providing a user interface to allow a user to create a user-modified snapshot of a hypothetical distributed computer system, the snapshot including configurations of at least some components of the hypothetical distributed computer system; and
executing a resource allocation process using the user-modified snapshot of the hypothetical distributed computer system to produce resource allocation results the hypothetical distributed computer system.

22. The computer-readable storage medium of claim 21, wherein the steps further comprises creating an original snapshot of an actual distributed computer system, wherein the user-modified snapshot is derived from the original snapshot.

23. The computer-readable storage medium of claim 22, wherein the steps further comprises obtaining a snapshot clone of the original snapshot of the actual distributed computer system, wherein the user-modified snapshot is a modified version of the snapshot clone.

24. The computer-readable storage medium of claim 22, wherein the user-modified snapshot is a modified version of the original snapshot of the actual distributed computer system.

25. The computer-readable storage medium of claim 22, wherein the original snapshot of the actual distributed computer system includes configurations and resource usage information of at least some components of the actual distributed computer system.

26. The computer-readable storage medium of claim 25, wherein the original snapshot of the actual distributed computer system includes configurations of host computers in the actual distributed computer system and clients running on at least some of the host computers.

27. The computer-readable storage medium of claim 25, wherein the original snapshot of the actual distributed computer system includes configurations of storage devices in the actual distributed computer system.

28. The computer-readable storage medium of claim 22, wherein the original snapshot of the actual distributed computer system includes requirements of at least some components of the actual distributed computer system.

29. The computer-readable storage medium of claim 28, wherein the original snapshot of the actual distributed computer system includes requirements of clients running on host computers in the actual distributed computer system.

30. The computer-readable storage medium of claim 29, wherein the clients running on the host computers in the actual distributed computer system include virtual machines.
